(19) United States
(12) Patent Application Publication
(10) Pub. No.: US 2006/0284856 A1
(43) Pub. Date: Dec. 21, 2006

(54) Sensor signal conditioning in a force-based touch device

(76) Inventor: David A. Soss, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/402,985

(22) Filed: Apr. 11, 2006

Related U.S. Application Data
(60) Provisional application No. 60/708,867, filed on Aug. 16, 2005.
(60) Provisional application No. 60/689,731, filed on Jun. 10, 2005.

(51) Int. Cl. G09G 5/00

(52) U.S. Cl. 345/173

(57) ABSTRACT

Disclosed is method and device for signal conditioning in a force-based touch screen. In one embodiment, signal conditioning includes multiplying a force signal by a scaling signal which is a predetermined function of the total force applied to the force-based touch screen and integrating the force signal over a touch event.

### CROSS REFERENCE TO RELATED APPLICATIONS

This application claims the benefit of U.S. Provisional Patent Application Ser. No. 60/708,867 filed Aug. 16, 2005, entitled “Force-Based Input Device” and U.S. Provisional Patent Application Ser. No. 60/689,731 filed Jun. 10, 2005, entitled “Signal Conditioning in a Force-Based Touch Device,” each of which is hereby incorporated by reference in their entirety for all purposes.

### FIELD OF THE INVENTION

The present invention relates generally to force-based input devices, and more particularly to signal conditioning in force-based input devices, wherein signals from force sensors in the force-based input device are conditioned and processed to obtain specific characteristics about or related to an applied force, such as its location and magnitude.

### BACKGROUND OF THE INVENTION AND RELATED ART

Input devices (e.g., a touch screen or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, automatic teller machines, point of sale terminals, vending machines, medical devices, keypads, keyboards, and others.

Force-based input devices are configured to measure the location and magnitude of the forces applied to and transmitted by the input pad. Force-based input devices comprise one or more force sensors that are configured to measure the applied force, either directly or indirectly. Various types of force sensors can be used, including for example piezoresistive sensors and piezoelectric transducers. The force sensors can be operated with gloved fingers, bare fingers, styli, pens, pencils or any object that can apply a force to the input pad. Typically, location and magnitude of the applied force is determined by solving mechanical moment equations for which the inputs are the forces measured by the force sensors.

Determining the location and magnitude of the applied force is complicated by a number of factors. The force sensors can be affected by both electronic noise (e.g., thermal noise or received electromagnetic interference) and mechanical noise (e.g., force inputs from vibration or ambient environmental conditions). Force sensor output can also drift with time due to aging, temperature changes, and other factors.

Additional difficulties are also presented by human touches, which can be erratic and inconsistent. For example, hard touches can cause the force-based input device and force sensors to respond non-linearly, for example, driving components into saturation. Conversely, soft touches can be difficult to detect and result in inaccurate locations due to a low signal to noise ratio in the force sensor signal. The point where the touch force is applied can also move during the touch. One approach to these challenges is to sample the force sensor outputs at the peak of the applied force. It can be difficult, however, to determine the correct timing of the peak, and a peak detector can be sensitive to noise spikes occurring near time of the peak. Complications also arise when any of the force sensors are saturated during the peak. An alternate approach is to average the force sensor outputs over a touch, but this approach can have the effect of reducing the signal to noise ratio because noise during soft portions of the touch is included in the average. Averaging can also accentuate errors resulting from drift or baseline errors in the sensors.

### SUMMARY OF THE INVENTION

In light of the problems and deficiencies inherent in the prior art, the present invention seeks to overcome these by providing signal conditioning for a force-based input device that can enhance the accuracy in determining the location and magnitude of an applied force.

In accordance with the invention as embodied and broadly described herein, the present invention features a method for conditioning a force sensor signal in a force-based input device having a plurality of force sensor signals. In one exemplary embodiment, the method includes accepting a total force signal which is related to a magnitude of a force applied to the force-based input device and converting the total force signal to a scaling signal according to a predefined function. The method can also include multiplying the force signal by the scaling signal to form a product signal and integrating the product signal during a touch event to obtain a conditioned signal.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a flow chart of a method for conditioning a force sensor signal in accordance with an embodiment of the present invention;

FIG. 2 illustrates a flowchart of a method for estimating a touch location on a force-based input device in accordance with an embodiment of the present invention;

FIG. 3 illustrates a device for conditioning a plurality of force sensor signals in accordance with an embodiment of the present invention;

FIG. 4 illustrates a circuit for determining a touch event in accordance with an embodiment of the present invention;

FIG. 5 illustrates an alternate circuit for determining a touch event in accordance with an embodiment of the present invention; and

FIG. 6 illustrates an alternate device for conditioning a plurality of force sensor signals in accordance with an embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

Generally, the present invention describes signal conditioning techniques for force sensor signals in a force-based input device. The force-based input device includes a plurality of force sensors outputting a plurality of force sensor signals. The force sensor signals provide measurements of force transmitted to each force sensor by a touch or other applied force to the force-based input device. As noted above, the force can be applied by a variety of objects, including for example, a stylus or finger. For example, one force-based input device suitable for use with embodiments of the present invention is disclosed in commonly owned co-pending U.S. patent application Ser. No. ______, (attorney docket 24347.NP) filed the same day as the present application and entitled “Force-Based Input Device,” which is herein incorporated by reference for all purposes.

Typically, force sensor signals are provided by the force-based input device as analog signals. Analog signals may be processed in various ways, including for example using discrete components and analog integrated circuits. The force sensor signals may also be sampled and digitized, for example, using an analog to digital converter to provide digital, time-sampled data. For example, force sensor signals can be sampled at a rate between 25 and 200 samples per second, although other rates may prove advantageous as well. It is desirable, but not essential, that the sample rate be relatively high compared to the dynamics of the touch. Digitization can be performed with 16-bit resolution, although other resolutions may prove advantageous as well. Digital, time-sampled data may be processed in various ways, including for example, using a microprocessor, microcontroller, discrete logic, application specific integration circuit, or field programmable gate array. Components used to implement the techniques disclosed herein can also be shared with other functions. For example, a microprocessor may be programmed to perform both the signal conditioning described herein and an application which accepts input from the force-based input device. Various suitable detailed implementations of the methods and apparatuses disclosed herein will occur to one skilled in the art in possession of this disclosure.

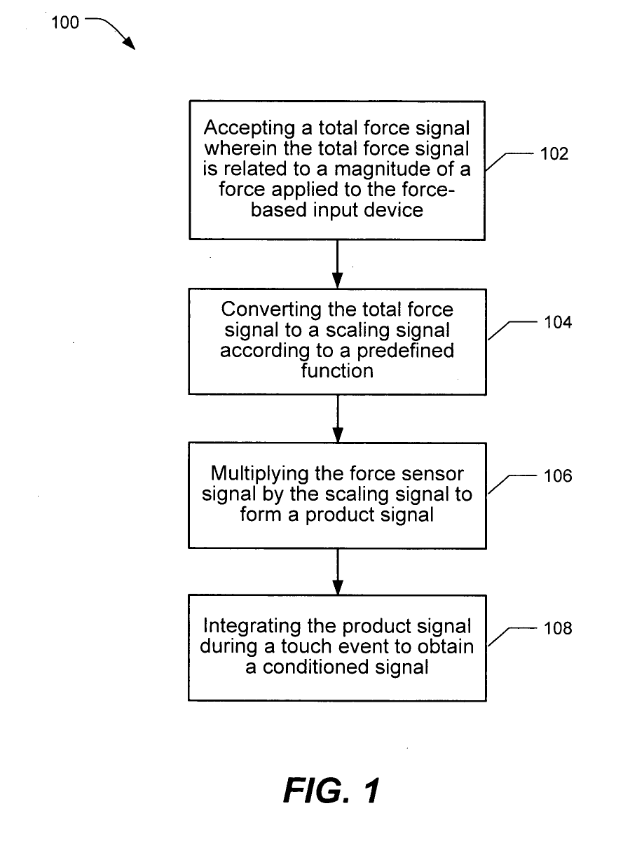

As illustrated in FIG. 1, a flowchart of a method for conditioning a force sensor signal is illustrated in accordance with an exemplary embodiment of the present invention. The method, shown generally at 100, includes accepting 102 a total force signal which is related to a magnitude of a force applied to the force-based input device. For example, the total force signal may be provided by a force sensor in the force-based input device which directly senses the total force applied to the device. As another example, the total force signal may be obtained by summing a plurality of force sensor signals provided by the force-based input device. As yet another example, the total force signal may be obtained by selecting a maximum of the plurality of total force sensor signals.

The method includes converting 104 the total force signal to a scaling signal according to a predefined function, multiplying 106 the force sensor signal by the scaling signal to form a product signal, and integrating 108 the product signal during a touch event to obtain a conditioned signal. The conditioned signal is thus similar to a weighted average of the force sensor signal, where the weighting function is the predefined function of the total force signal.

The predefined function may be selected to emphasize different time portions of the force sensor signal. For example, the predetermined function may be selected so that the scaling signal is a positive slope linear function of the total force signal, resulting in increased emphasis on portions of the force sensor signal during which the total force signal is largest. By emphasizing portions of the force sensor signal where the applied total force is larger relative to portions where the applied total force is smaller, the method 100 can provide an increased signal to noise ratio in the conditioned signal as compared to simple averaging. This increased signal to noise ratio can translate into improved accuracy when characteristics of a touch on the input device are determined, such as the location or magnitude of the applied force.

The use of the predefined function in the method provides significant flexibility in as compared to a peak detecting or averaging system. In general, the predefined function can be a linear function, a non-linear function, or even a discontinuous function. The predefined function is not degenerate, in that the output of the predefined function varies with the input (as opposed to being merely a constant). For example, using a predefined function where the scaling signal is an increasing function of the total force signal (e.g., square law or other monotonic increasing function) will cause the conditioned signal to have characteristics similar to a peak detector. Predefined functions such as a square law, n^{th}-power law, exponential, exponential of the square, etc., provide increasing peak detecting effects. Predefined functions such as square root or logarithm provide a less strong peak detecting effect. Hence, the method 100 can provide an effect similar to peak detection, but with less sensitively and complexity than prior art techniques. For example, one advantage of the method over a conventional peak detector is that the force sensor signal is integrated over a period of time, rather than taking a single sample at one point in time. This integration can result in increased signal to noise ratio, for example, by averaging out noise which occurs near the time of the peak.

Alternately, using a predefined function for which the scaling signal changes little as a function of the total force signal or is a decreasing function of the total force signal will cause the conditioned signal to have characteristics more like an average. An advantage of the method over averaging, however, is that portions of the touch which are likely to be reliable (e.g., high touch force) are emphasized and portions of the touch which are likely to be unreliable (e.g., light touch force or sliding movements) are deemphasized. By suitable selection of the predefined function, a compromise between averaging and peak detection can thus be obtained. For example, use of a linear function proves particularly advantageous given its simplicity.

The predefined function may also be selected to be a discontinuous function. Discontinuous functions may prove advantageous, for example, in handling non-linear effects in the force sensors. For example, the predetermined function may be defined to output zero when the total force exceeds a limit known to drive the force-based input device or force sensors into non-linear behavior. As another example, the predetermined function may be defined to output zero when the total force is below a limit known to be too small a force for reliable calculation.

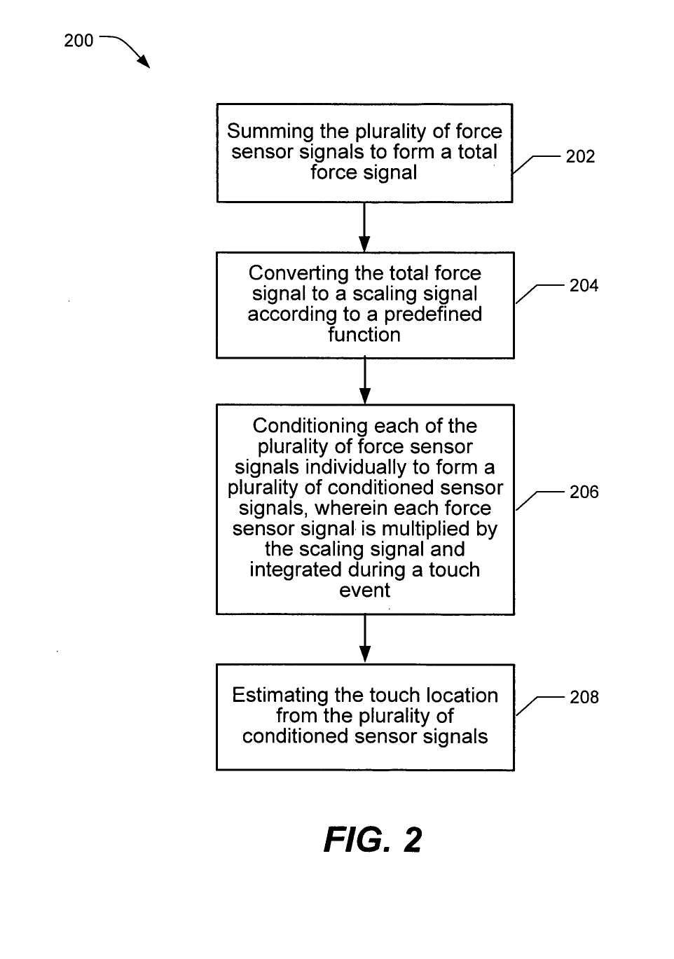

The method may also be used to condition a plurality of force sensor signals. For example, all of the force sensor signals in the force-based input device can be conditioned, multiplying each of the plurality of force sensor signals by the scaling signal to form a plurality of product signals and integrating each of the plurality of product signals during the touch event to obtain a plurality of conditioned signals. The plurality of conditioned signals may then be used to estimate the location of the applied force, for example, as discussed in further detail below FIG. 2 provides a flowchart of a method for estimating a touch location on a force-based input device, in accordance with another exemplary embodiment of the present invention. As discussed above, the force-based input device may include a plurality of force sensors outputting a plurality of force sensor signals providing measurements of force transmitted to each sensor by a touch force applied to the force-based input device. The method, shown generally at 200, includes summing 202 the plurality of force sensor signals to form a total force sensor signal and converting 204 the total force signal to a scaling signal according to a predefined function. For example, for a set of force sensor signals {Sᵢ(t)}, where i=1 . . . M, M is the number of sensors, and t represents time, the scaling signal W(t) is given by

$$W ( t ) = 𝒫 ( {\sum }_{i = 1}^{M} {S}_{i} ( t ) )$$

where P(·) is the predefined function, as discussed above.

The method 200 includes conditioning 206 each of the plurality of force sensor signals individually to form a plurality of conditioned sensor signals. Each force sensor signal is conditioned by multiplying the force sensor signal by the scaling signal and then integrating during a touch event. For example, conditioned sensor signal S′ᵢ is given by
S′ᵢ=∫W(t)Sᵢ(t)dt
where the integration is performed over the touch event. Of course, as will be appreciated by one skilled in the art, this integration can be estimated on time sampled data by performing a summation, e.g.,

$${S}_{i}^{′} = \sum {S}_{ik} 𝒫 ( {\sum }_{j = 1}^{M} {S}_{jk} ) ,$$

where Sᵢₖ represents the output of sensor i sampled at sample k. The summation is performed over the touch event, as discussed in further detail below. The summation can be performed on the fly, on a sample by sample basis, thus avoiding the need to store multiple samples of the force sensor signal.

The method also includes estimating 208 the touch location from the plurality of conditioned sensor signals. Various techniques for estimating the touch location from a plurality of sensor signals can be applied within the context of the presently disclosed embodiments. For example, U.S. Pat. No. 4,121,049 to Roeber and U.S. Pat. No. 4,340,772 to De Costa et al. disclose known techniques for estimating the touch location and magnitude of the touch which are hereby incorporated by reference. As another example, touch location [x y] may be determined from

$$[ \begin{matrix}x & y\end{matrix} ] = \frac{\begin{matrix}[ {S}_{1}^{′} & ⋯ & {S}_{M}^{′} ] [ \begin{matrix}{x}_{1} & & {y}_{1} \\ & ⋮ & \\ {x}_{M} & & {y}_{M}\end{matrix} ]\end{matrix}}{\sum {S}_{i}^{′}}$$

where the vectors {[xᵢ yᵢ]} are the locations of the sensors. The origin of the coordinate system can be selected as an arbitrary point, for example the center of the force-based input device or one of the force sensor locations. Note that the locations of the force sensors may be either the actual location of the force sensors on the force-based input device or an effective location as determined by calibration or otherwise. For example, calibration may be performed by touching the screen at several different known locations, calculating the location from the above equation treating the force sensor locations as unknown, and then performing an error minimization (e.g., minimum square error) to find a set of effective force sensor locations which results in minimum average squared error. For example, U.S. Pat. No. 4,745,565 to Garwin et al. discloses a calibration technique suitable for use with embodiments of the present invention which is hereby incorporated by reference.

Of course, the touch force may be applied over an area (for example, when a finger is used on an input device relatively small in comparison to the size of the finger tip), in which case the touch location is not an exact point. Typically, the touch location is estimated as though the force is concentrated at a single point (which will be approximately the centroid of the applied force).

The estimated touch location can also be corrected for calibration errors by applying a polynomial correction as will now be described. It has been discovered that systematic errors can occur in the estimated touch location in the form of magnification errors. These errors can be corrected as follows. It is convenient to define a normalized touch location as

$$\overline{x} ≡ \frac{x - {X}_{0}}{{X}_{1}}$$

$$\overline{y} ≡ \frac{y - {Y}_{0}}{{Y}_{1}}$$

where X₀ and Y₀ represent the center of the input pad and X₁ and Y₁ represent a reference point. By center is meant a point roughly equidistant from the force sensor location. The center can also be defined as the intersection of the lines of symmetry of the sensor location. Alternately, the values of X₀ and Y₀ can be determined experimentally. The reference point may be chosen arbitrarily, but choosing one of the sensor locations as the reference point is also convenient. The corrected location \tilde{x}, \tilde{y} is then formed by applying the correction factors
\tilde{x}=xmₓ(\overline{x},\overline{y})\tilde{y}=ym_{y}(\overline{x},\overline{y})
where polynomial correction factors are given by,
mₓ(\overline{x},\overline{y})=A₀+A₂\overline{x}² . . . +Aₚ\overline{x}^{p}+B₁\overline{y}+B₂\overline{y}² . . . +B_{q}\overline{y}^{q}
m_{y}(\overline{x},\overline{y})=C₀+C₁\overline{x}+C₂\overline{x}² . . . +Cᵤ\overline{x}^{u}+D₂\overline{y}² . . . +Dᵥ\overline{y}^{v}
The constants can be determined experimentally, for example using the techniques described above. Note that constants B₀ and D₀ can be omitted, since these are redundant. Similarly, A₁\overline{x} and D₁\overline{y} terms can be omitted since these terms have the same effect as a change in the reference point. The coefficients A₀ and C₀ can be chosen so that
mₓ(1,1)=m_{y}(1,1)=1.
This has effect of leaving the position of the reference point unchanged.

The even order terms represent symmetric distortions, and the odd order terms represent asymmetric distortions. The coefficients can be chosen so that the sum of the odd terms of mₓ(1,1)=0 and the sum of the odd terms of m_{y}(1,1)=0. This has the effect that the magnification is symmetrical about the center and helps to avoid redundancy with other calibration coefficients

In experiments, it was discovered that, for some configurations of the force-based input device, excellent performance can be obtained using only the constant and quadratic terms, e.g.,
mₓ(\overline{x},\overline{y})=A₀+A₁\overline{x}²+B₂\overline{y}²
m_{y}(\overline{x},\overline{y})=C₀+C₂\overline{x}²+D₂\overline{y}².

A quality measure can also be obtained to provide an indication of the expected accuracy of the estimated touch location. For example, the quality measure can be obtained from a scaling total by integrating the scaling signal during the touch event to form a scaling total. For example, the scaling total, D, may be calculated from

$$D = \int W ( t ) = {\int }_{}^{} 𝒫 ( {\sum }_{i = 1}^{M} {S}_{i} ( t ) ) ⅆ t$$

where the integration is performed over the touch event. In the case of time sampled sensor signals, the scaling total is given by

$$D = \sum 𝒫 ( {\sum }_{j = 1}^{M} {S}_{j , k} )$$

where the summation is performed over the range of time sample indices, k, corresponding to the touch event. Alternately, the integration (or summation) may be calculated on an ongoing basis, updating the integration (sum) as each new set of force sensor samples is received, by which a quality is measure is available at any point during the touch event.

The scaling signal is like an instantaneous measure of the quality of the touch: larger values are weighted more in the sensor signal integrations because they are more reliable. Hence, the scaling total is related to a measure of the total quality of the touch. For longer touch events, a longer integration is performed providing higher signal to noise ratio in the conditioned signals, and the scaling total will increase indicating improved quality. For example, a long, light touch may provide similar accuracy as a short, strong touch. Hence, a quality measure obtained from the scaling total provides a significant improvement over previous quality measures based solely on the time duration or peak force of the touch event. Optionally, touches which do not provide a sufficiently high quality, e.g., D does not exceed a predetermined quality threshold, may be rejected.

An estimate of the total force of the touch may also be obtained from the scaling total by calculating

$$F = \frac{{\sum }_{i = 1}^{M} {S}_{i}^{′}}{D} .$$

The division by the scaling total D normalizes for the effect of the scaling signal. The estimated total force can be used for similar purpose as the quality measure. The estimate of total force can be provided as an output of the method.

Optionally, the step of conditioning the force sensor signal may further include dividing the conditioned force sensor signal by the scaling total. This is not essential, as it can be seen from above that the estimation of the touch location can be insensitive to scale factor in the conditioned sensor signals for some techniques of estimating touch location.

The method can also include compensating each of the force sensor signals for baseline error before summing, converting, or conditioning. For example one suitable technique for compensating for baseline error is described in commonly owned co-pending U.S. patent application Ser. No. ______, (attorney docket 24415.NP2) filed the same day as the present application and entitled “Sensor Baseline Compensation in a Force-Based Touch Device,” which is herein incorporated by reference for all purposes. In addition, correction factors for gain and non-linearity of the sensors can be determined experimentally using error minimization techniques in a manner similar to determining calibration constants for the estimated touch location.

Various aspects of the processing for the force-based input device may depend on the beginning or end of the touch event. For example, as discussed above, conditioning the force sensor signal includes integration (or summation) over the touch event. Different ways of defining the time extent of a touch event can be used, depending on what the begin or end of the touch event is being used for. For example, one definition of the touch event may be used for starting and stopping the integration. Another definition of a touch event may be used for output of touch-begin and touch-end information from the force-based input device. Yet another definition of a touch event may be used for updating baseline information. Accordingly, several different techniques for determining the begin and end of a touch event will now be discussed.

As a first example, the total force signal may be used to determine a time limit of the touch event. In one embodiment, the start of a touch event can be declared when the total force signal exceeds a first predetermined threshold. In another embodiment, the end of a touch event can be declared at the time the total force signal drops below a second predetermined threshold. The second predetermined threshold may be equal to or different than the first predetermined threshold. For example, it may be desirable to set the first predetermined threshold higher than the second predetermined threshold to help prevent a premature end of touch event declaration. For example, setting the second predetermined threshold to 95% of the first predetermined threshold has proven useful in one embodiment. Typically, the first predetermined threshold will be set to be a multiple of the expected noise variance of the total force signal. For example, the first predetermined threshold may be set to 6, 12, or 20 times the expected noise variance. The threshold level chosen depends on the desired position accuracy, with a larger threshold resulting in better accuracy at the expense of reduced touch sensitivity. The expected noise variance may be predetermined, or may be determined experimentally during operation.

For force-based input devices which can detect force applied to either side, the total force signal can be either positive or negative. In this case, it may be desirable to provide both a positive and a negative first predetermined threshold for determining the start of a touch event. The end of a touch event may be determined by using a threshold for which the signal depends on whether the positive or negative threshold was exceeded.

As another example, piezoelectric force sensors can provide two pulses, one at the beginning of a touch and one at the end of the touch, each pulse being of opposite polarity. In this case, it may be desirable to set a release threshold which is the opposite sign of the beginning touch pulse and declare end of touch when the release threshold is exceeded. Alternately, it may be preferable to perform the integration only during times when the signal exceeds a threshold, separately from the determination of an end of touch event.

An alternate approach to determining the end of a touch event, for example to trigger calculation and/or output of determined touch location, is based on the use of the quality factor, D. The quality factor can be updated when each set of force sensor input samples is received, and an end of touch declared when the quality exceeds a third predetermined threshold. For example, the third predetermined threshold may correspond to a quality level at which a reliable touch location position can be estimated.

Touch events may also be determined in part by using a predetermined time interval. For example, the end of a touch event may be declared at a predetermined time after the beginning of a touch event is detected as described above. In this case, conditioning the sensor samples may begin whenever the beginning of a touch event is detected, and continued for a fixed period of time (e.g., a fixed number of samples). This implementation provides the advantage that minimal buffering of force sensor signal samples is necessary. For example, a predetermined time interval of 0.25 seconds has proven useful in one embodiment. Additionally, a time limit can help to meet user expectations about the behavior of the force-based input device. For example, when a user touches a device, they expect something to happen. A timer can enable a position calculation before the user releases the touch. Hence, different touch event limits may be applied to the integration and to other processing within the force-based input device.

Alternately, the end of a touch event may be detected by comparison to the second predetermined threshold as described above, and the predetermined time interval used to determine the beginning of the touch event earlier in time. Implementation of this latter example may be accomplished, for example, by buffering a number of samples of each of the plurality of force sensor signals and conditioning the buffered samples of the force sensor signals when the end of a touch event occurs.

As yet another alternative, the end of the touch event can be determined using a combination of the techniques, taking the earlier of the predetermined time interval after the start of the touch event and the time when the total force signal drops below the second predetermined threshold.

As yet another alternative, the touch event may be defined to exclude periods of time during which one or more force sensors are in saturation or non-linear behavior, disabling the integrators during such time intervals or samples. For example, when a force sensor is in saturation, the range may go to zero, at which point detection of a touch event becomes difficult.

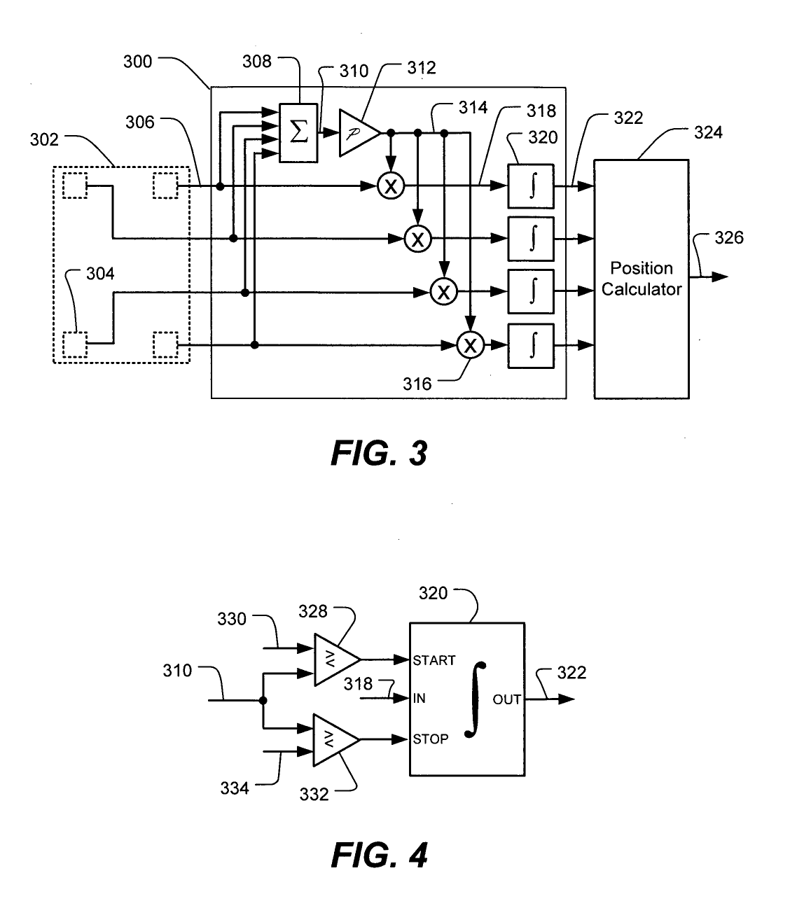

In accordance with another embodiment of the present invention, a device for conditioning a plurality of force sensor signals is illustrated in block diagram form in FIG. 3. The device, shown generally at 300, accepts a plurality of force sensor signals 306 created by a plurality of force sensors 304 in a force-based input device 302. The force sensors sense a touch force applied to the force-based input device, and output force sensor signals which provide a measurement of the force transmitted to each force sensor.

The device 300 includes a summer 308, scaling amplifier 312, plurality of multipliers 316, and plurality of integrators 320. The summer 308 sums the force sensor signals to form a total force signal 310. The total force signal is converted by the scaling amplifier 312 into a scaling signal 314. The scaling signal is a predefined function of the total force signal, for example, a linear function as described above.

The force sensor signals 306 are each accepted by a corresponding multiplier 316, which multiplies the force sensor signal by the scaling signal 314. The resulting scaled sensor signals 318 are supplied to corresponding integrators 320 which integrate the scaled sensor signal to form conditioned signals 322.

In another embodiment of the present invention, the device 300 can also include a position calculator 324. The position calculator can be coupled to the integrators to receive the plurality of conditioned signals 322 from which a location of the touch force is estimated. The estimated touch location 326 can be output from the position calculator. Various techniques for implementing the position calculator will be apparent from above discussion of other embodiments of the invention.

The integrators can be configured to integrate during a touch event. Note that a touch event, as defined, need not precisely correspond to the actual duration over which a touch force is applied to the force-based input device. For example, as discussed above, the touch event can be determined by comparing the total force signal to one or more predefined thresholds, by using predetermined time intervals, or by using a combination of both predefined thresholds and predetermined time intervals. Thus, the device can include circuitry for determining a touch event as illustrated in FIG. 4 in accordance with one embodiment of the present invention. The circuitry can include a first comparator 328 which is configured to receive the total force signal 310 and to start the integrators 320 when the total force signal is greater than a first predefined threshold 330. Thus, when there is a touch on the screen, as the total force signal rises from its baseline level, it may cross the first predefined threshold, at which point the touch event begins, and the integrators are started. In accordance with another embodiment, the circuitry can also include a second comparator 332 configured to stop the integrators when the total force signal is less than a second predefined threshold 334. Thus, when the touch is released, the total force signal will eventually drop below the second predefined threshold, at which point the touch event ends and the integrators are stopped.

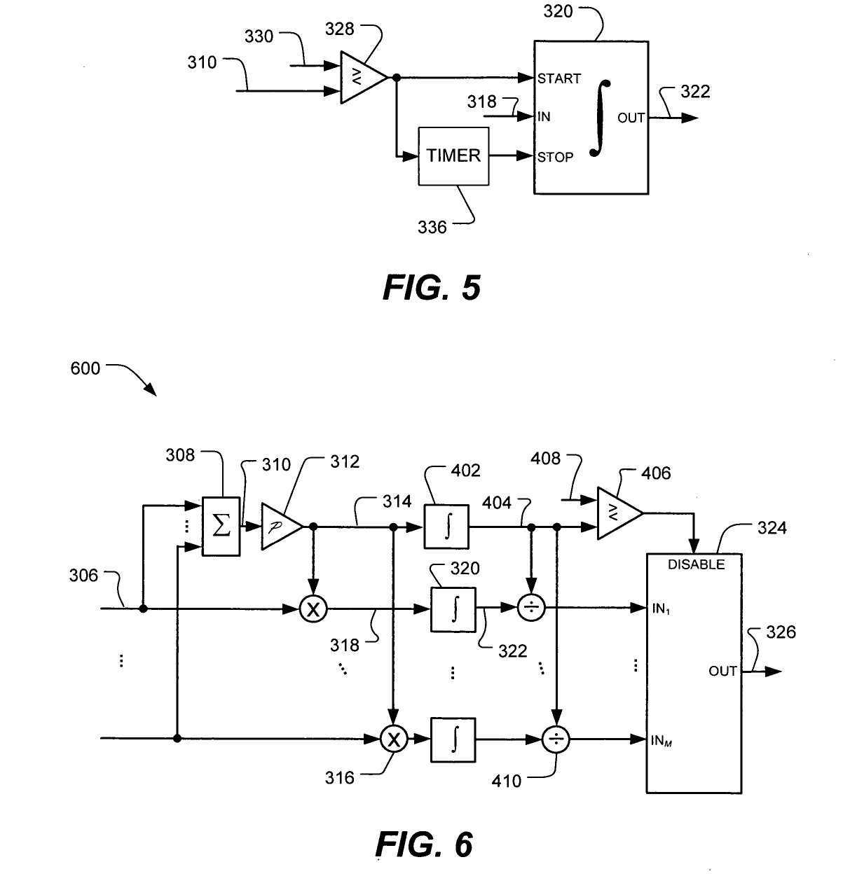

An alternate embodiment of circuitry for determining a touch event is illustrated in FIG. 5, where the touch event is based in part on a predefined time interval. The circuitry includes a timer 336 coupled to the first comparator and the plurality of integrators and configured to stop the integrators 320 a predetermined time interval after the start of the touch event. Thus, a touch event begins when the total force signal 310 exceeds the first predetermined threshold 330, as described above. The touch event ends a predefined time interval later.

As an alternative to using the total force signal 310 to determine the beginning and end of touch events, the scaling signal 314, or a scaling total 404 (FIG. 6) (discussed below) can be used instead, performing comparisons to predefined thresholds as discussed above.

An alternate embodiment of a device for conditioning a plurality of force sensor signals is illustrated in block diagram in FIG. 6. The device, shown generally at 600, operates similarly as described above. The device also includes a second integrator 402. The second integrator integrates the scaling signal 314 to produce a scaling total 404. As discussed above, the scaling total can be used as an indication of the reliability of an estimated touch location. Accordingly, the device may also include a third comparator 406, configured to disable output from the position calculator when the scaling total is less than a third predetermined threshold.

Optionally, the device may include a plurality of dividers 410. The dividers divide the conditioned signals 322 by the scaling total 404 before they are provided to the position calculator 324. This division, although not generally required for the position calculator, may prove useful in some implementations.

It will be appreciated by one skilled in the art that the devices 300 (FIG. 3) and 600 (FIG. 6) may also include various filters (not shown). For example, the force sensor signals may be low-pass filtered to de-emphasize frequency components not related to touch-forces, for example high frequency noise. More particularly, a low-pass filter with a 3 dB cutoff of 10 Hz has proven useful in one embodiment. Optionally, the filtering can include equalization, time shifting, baseline compensation, or other processing to minimize differences between different force sensors. For example, if the force sensor signals are sequentially sampled, interpolation may be performed to produce new samples which are correctly time aligned. Accordingly, filter coefficients may consist of one common set for all channels or may consist of different sets for each channel in order to provide equalization and time shifting. Filtering may also include correcting for scale constants, non-linearity, and other factors as will occur to one skilled in the art.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and are not to be limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where, for a specific claim limitation, all of the following conditions are present: a) “means for” or “step for” is expressly recited in the claim limitation; b) a corresponding function is expressly recited in the claim limitation; and c) structure, material or acts that support that structure are expressly recited within the specification. Accordingly, the scope of the invention should be determined solely by the appended claims and their legal equivalents, rather than by the descriptions and examples given above.

What is claimed and desired to be secured by Letters Patent is:

1. A method for estimating a touch location on a force-based input device, the force-based input device having a plurality of force sensors outputting a plurality of force sensor signals, the force sensor signals providing measurements of force transmitted to each force sensor by a touch force applied to the force-based input device, the method comprising:
summing the plurality of force sensor signals to form a total force signal;
converting the total force signal to a scaling signal according to a predefined function;
conditioning each of the plurality of force sensor signals individually to form a plurality of conditioned sensor signals, wherein each force sensor signal is multiplied by the scaling signal and integrated during a touch event; and
estimating the touch location from the plurality of conditioned sensor signals.

2. The method of claim 1, further comprising integrating the scaling signal during the touch event to form a scaling total.

3. The method of claim 2, further comprising calculating a quality measure from the scaling total.

4. The method of claim 2, further comprising rejecting touch events when the scaling total is less than a predetermined quality threshold.

5. The method of claim 2 wherein the step of conditioning each of the force sensor signals further comprises dividing each of the plurality of conditioned sensor signals by the scaling total.

6. The method of claim 1, further comprising comparing the total force signal to a predetermined threshold to determine a time limit of the touch event.

7. The method of claim 6, further comprising using a predetermined time interval to determine a time extent of the touch event.

8. The method of claim 1, wherein the predetermined function is a linear function.

9. The method of claim 1, wherein the predetermined function is an increasing function.

10. The method of claim 1, wherein the predetermined function goes to zero in at least one predetermined range.

11. The method of claim 1, wherein the predetermined function is a chosen from the group of functions consisting of square law, exponential, and polynomial.

12. In a force-based input device having a plurality of force sensor signals, a method for conditioning a force sensor signal comprising:
accepting a total force signal wherein the total force signal is related to a magnitude of a force applied to the force-based input device;
converting the total force signal to a scaling signal according to a predefined function;
multiplying the force sensor signal by the scaling signal to form a product signal; and
integrating the product signal during a touch event to obtain a conditioned signal.

13. The method of claim 12, further comprising summing the plurality of force sensor signals to form the total force signal.

14. The method of claim 12, further comprising:
multiplying each of plurality of force sensor signals by the scaling signal to form a plurality of product signals; and
integrating individually each of the product signals during the touch event to obtain a plurality of conditioned signals.

15. The method of claim 14, further comprising estimating the applied force location on the force-based input device from the plurality of conditioned signals.

16. A device for conditioning a plurality of force sensor signals created by a plurality of force sensors in a force-based input device, the force sensor signals providing measurements of force transmitted to each force sensor by a touch force applied to the force-based input device, the device comprising:
a summer configured to sum the plurality of force sensor signals and output a total force signal;
a scaling amplifier operatively coupled to the summer and configured to output a scaling signal which is a predefined function of the total force signal;
a plurality of multipliers operatively coupled to the scaling amplifier and configured to multiply each of the plurality of force sensor signals by the scaling signal and output a plurality of scaled sensor signals; and
a plurality of integrators operatively coupled to the plurality of multipliers and configured to integrate each of the scaled sensor signals and output a plurality of conditioned signals.

17. The device of claim 16, further comprising a position calculator operatively coupled to the plurality of integrators and configured to estimate a location of the touch force from the plurality of conditioned signals.

18. The device of claim 16, further comprising a first comparator operatively coupled to the summer and to the plurality of integrators and configured to start the integrators when the total force signal is greater than a first predefined threshold.

19. The device of claim 18, further comprising a timer operatively coupled to the first comparator and to the plurality of integrators and configured to stop the integrators after a predetermined time interval.

20. The device of claim 18, further comprising a second comparator operatively coupled to the summer and to the plurality of integrators and configured to stop the integrators when the total force signal is less than a second predefined threshold.

21. The device of claim 16, further comprising a second integrator operatively coupled to the scaling amplifier and configured to integrate the scaling signal to produce a scaling total.

22. The device of claim 21, further comprising a third comparator operatively coupled to the second integrator and the position calculator and configured to disable the position calculator when the scaling total is less than a third predetermined threshold.

23. The device of claim 21, further comprising a plurality of dividers operatively coupled to the second integrator and operatively coupled between the plurality of integrators and the position calculator and configured to divide each of the conditioned signals by the scaling total.

24. The device of claim 16, wherein the force sensor signals are time sampled digital signals.

25. The device of claim 16, further comprising the force-based input device coupled to the device for conditioning a plurality of force sensor signals.
